(19) United States
(12) Patent Application Publication
(10) Pub. No.: US 2025/0347628 A1
(43) Pub. Date: Nov. 13, 2025

(54) IRRADIATION DEVICE AND PHOTOMETRIC DEVICE

(71) Applicant: FUJIFILM CORPORATION, Minato-ku, Tokyo (JP)

(72) Inventors: Yuki ARAI, Kanagawa (JP); Yoshinobu MIURA, Kanagawa (JP)

(21) Appl. No.: 19/278,828

(22) Filed: Jul. 24, 2025

Related U.S. Application Data
(63) Continuation of application No. PCT/JP2024/000972, filed on Jan. 16, 2024.

(30) Foreign Application Priority Data
Feb. 10, 2023 (JP) 2023-019490

(51) Int. Cl. G01N 21/78; G01N 21/31; G01N 21/75

(52) U.S. Cl. CPC G01N 21/78; G01N 21/314; G01N 2021/3181; G01N 2021/757

(57) ABSTRACT

An irradiation device and a photometric device include a first light-emitting element and a second light-emitting, in which a relative positional relationship between the first light-emitting element and the second light-emitting element satisfies a first condition which is that the first and the second light-emitting elements are arranged at an interval of 90°˜180° as a central angle around the Z axis, and the second condition which is that one of a first intersection and a second intersection is located in a positive direction and another is located in a negative direction, where the first intersection intersects between a first light emission center axis and the Z axis, the second intersection intersects between a second light emission center axis and the Z axis, and the positive direction and the negative direction are respectively on one side and another side on the Z axis with respect to the XY plane.

### CROSS-REFERENCE TO RELATED APPLICATIONS

This application is a continuation of International Application No. PCT/JP2024/000972, filed on Jan. 16, 2024, which claims priority from Japanese Patent Application No. 2023-019490, filed on Feb. 10, 2023. The entire disclosure of each of the above applications is incorporated herein by reference.

### BACKGROUND

### 1. Technical Field

The present disclosure relates to an irradiation device and a photometric device.

### 2. Related Art

An analyzer apparatus for analyzing a test substance sample by measuring a reaction state between the test substance sample and a reagent has been known (see, for example, JP2008-522160A). As the reaction state measurement, for example, the concentration measurement on a test target substance contained in the test substance sample or the like is performed by measuring the reaction state. The test substance sample is, for example, blood, urine, and the like. In such an analyzer apparatus, an analytical chip (also referred to as a reagent test slide) including a reactive region containing a reagent is used.

A test substance sample is supplied to the reactive region of the analytical chip as described above, and a test target substance in the test substance sample reacts with the reagent in the reactive region. As a result, a reactant that develops color is generated. The concentration of the test target substance in the test substance sample can be measured by irradiating the reactive region with measurement light, including light of a wavelength to be absorbed by the reactant developing color, from a light source and acquiring a detection signal corresponding to output light output from the reactive region upon being irradiated with the measurement light.

JP2008-522160A proposes a light source (irradiation device) for providing a volume of homogeneous light irradiance in a plane including a reactive region, when irradiating the reactive region of an analytical chip with light.

### SUMMARY

Specifically, JP2008-522160A discloses a configuration in which preferably three or four light-emitting elements of the same wavelength are included, and the light emission center axes of the plurality of light-emitting elements are arranged to intersect at a position that is deviated from a plane (hereinafter referred to as a measurement reference plane) including the reactive region when the analytical chip is properly loaded at the load position, and is on the normal line (corresponding to the Z axis) of the measurement reference plane. Here, the light emission center axis refers to a straight line extending in the normal direction of the light-emitting surface from the light emission center matching the peak of the light intensity distribution in the light-emitting surface. This configuration is described to be capable of achieving substantially the same light irradiance (amount of illumination light), even when the reactive region of the actually loaded analytical chip is deviated with respect to the measurement reference plane in the Z axis direction.

However, when the plurality of light-emitting elements are arranged with the intersection of their light emission center axes being at a position on the Z axis and deviated from the measurement reference plane, irradiation regions of the plurality of light-emitting elements substantially coincide on a plane perpendicular to the Z axis and including the intersection of the light emission center axes, but deviation of the irradiation regions of the plurality of light-emitting elements on the plane perpendicular to the Z axis occurs and increases with the distance from the intersection in the Z axis direction. This may result in a large difference in the amount of illumination light on the reactive region between a case of deviation from the measurement reference plane toward the intersection side along the Z axis and a case of deviation from the measurement reference plane toward the side opposite to the intersection.

An object of the present disclosure is to provide an irradiation device and a photometric device capable of achieving a uniform amount of illumination light on a surface of a reactive region of an analytical chip and a small variation in the amount of illumination light attributable to deviation of a plane including the reactive region from a measurement reference plane in a normal direction compared with conventional cases.

An irradiation device according to the present disclosure is an irradiation device configured to irradiate a planar reactive region of an analytical chip with light when optically analyzing a test substance sample by using the analytical chip having the reactive region in which a reagent reacting with a test target substance contained in the test substance sample is immobilized, the irradiation device including at least two light-emitting elements including a first light-emitting element and a second light-emitting element as light-emitting elements configured to emit light in a same wavelength range, in which a relative positional relationship between the first light-emitting element and the second light-emitting element satisfies a first condition and a second condition below, where a normal direction of the reactive region of the analytical chip in a state of being properly loaded at a load position is defined as a Z axis, a plane including the reactive region is defined as an XY plane, and a straight line extending in a normal direction of a light-emitting surface of the light-emitting elements from a light emission center matching a peak of light intensity distribution in the light-emitting surface is defined as a light emission center axis,
the first condition relates to a relative positional relationship between the first light-emitting element and the second light-emitting element in a circumferential direction around the Z axis, and is a condition satisfied when the first light-emitting element and the second light-emitting element are arranged at an interval of 90° or more and 180° or less as a central angle around the Z axis, and
the second condition is a condition satisfied when one of a first intersection and a second intersection is located in a positive direction and another one of the first intersection and the second intersection is located in a negative direction, where the first intersection is an intersection between a first light emission center axis of the first light-emitting element and the Z axis, the second intersection is an intersection between a second light emission center axis of the second light-emitting element and the Z axis, and the positive direction and the negative direction are respectively on one side and another side on the Z axis with respect to the XY plane.

A distance to the first intersection from the XY plane is preferably equal to a distance to the second intersection from the XY plane.

The central angle is preferably 180°.

An angle formed by the light-emitting surface of the first light-emitting element and the XY plane is preferably equal to an angle formed by the light-emitting surface of the second light-emitting element and the XY plane, and the first light-emitting element and the second light-emitting element preferably have different Z coordinates.

$$\sqrt{X {1}^{2} + Y {1}^{2} + Z {1}^{2}} = \sqrt{X {2}^{2} + Y {2}^{2} + Z {2}^{2}}$$

is preferably satisfied, where an origin is a center of the reactive region of the analytical chip in a state of being properly loaded at the load position, X1, Y1, and Z1 denote a position of the first light-emitting element, and X2, Y2, and Z2 denote a position of the second light-emitting element.

A plurality of light-emitting element pairs each including a set of the first light-emitting element and the second light-emitting element may be included, the light-emitting element pairs being different from each other in wavelength range.

A sum of a first inclination angle between a straight line connecting a center of the first light-emitting element to the origin and the Z axis and a second inclination angle between a straight line connecting a center of the second light-emitting element to the origin and the Z axis is preferably same between at least two light-emitting element pairs among the plurality of light-emitting element pairs.

When the sum of the first inclination angle and the second inclination angle is the same between the two light-emitting element pairs, the first inclination angle and the second inclination angle of one of the two light-emitting element pairs are preferably the same as one of the first inclination angle and the second inclination angle of another one of the two light-emitting element pairs.

The light-emitting elements are preferably light-emitting diodes.

A photometric device according to the present disclosure is a photometric device configured to optically analyze a test substance sample by using an analytical chip having a reactive region where a reagent reacting with a test target substance is immobilized, the photometric device including:
the irradiation device of the present disclosure; and
a photodetector configured to detect output light output from the analytical chip when the analytical chip is irradiated with the light and output a detection signal corresponding to the output light.

According to the technique of the present disclosure, it is possible to achieve a uniform amount of illumination light on a surface of a reactive region of an analytical chip and reduce a variation in the amount of illumination light attributable to deviation of a plane including the reactive region from a measurement reference plane in a normal direction, from that in conventional cases.

### BRIEF DESCRIPTION OF THE DRAWINGS

FIG. 1 is a schematic diagram illustrating an overall configuration of an analyzer apparatus according to an embodiment;

FIG. 2 is a plan view of a main part of the analyzer apparatus in FIG. 1;

FIG. 3 is a cross-sectional view of a transportation path portion of an analytical chip;

FIG. 4A is a perspective view of the analytical chip, and FIG. 4B is a plan view of a back surface of the analytical chip;

FIG. 5 is a schematic diagram illustrating a schematic configuration of a photometric unit and a positional relationship between the photometric unit and the analytical chip;

FIG. 6 is a perspective view illustrating a positional relationship among the analytical chip, a first light-emitting element group, a second light-emitting element group, and a photodetector;

FIG. 7 is a plan view of the irradiation device and the photodetector as viewed from a rotary substrate side;

FIG. 8 is a diagram illustrating a positional relationship between a measurement reference plane and a first light-emitting element and a second light-emitting element;

FIG. 9 is a diagram illustrating a positional relationship among the measurement reference plane, a first light-emitting element pair, and a second light-emitting element pair;

FIG. 10 is a plan view illustrating a modification of the irradiation device;

FIG. 11 is a diagram illustrating an arrangement of light-emitting elements in a configuration example used in a simulation;

FIG. 12 is a diagram illustrating an arrangement of light-emitting elements in a comparative example used in the simulation; and

FIG. 13 is a diagram illustrating a variation in the amount of illumination light with a change in the height-direction position obtained by the simulation.

### DESCRIPTION OF EMBODIMENTS

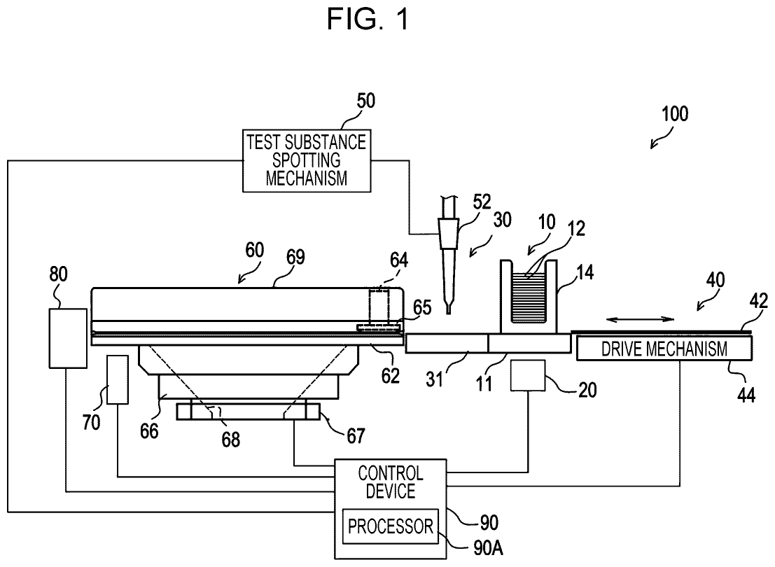

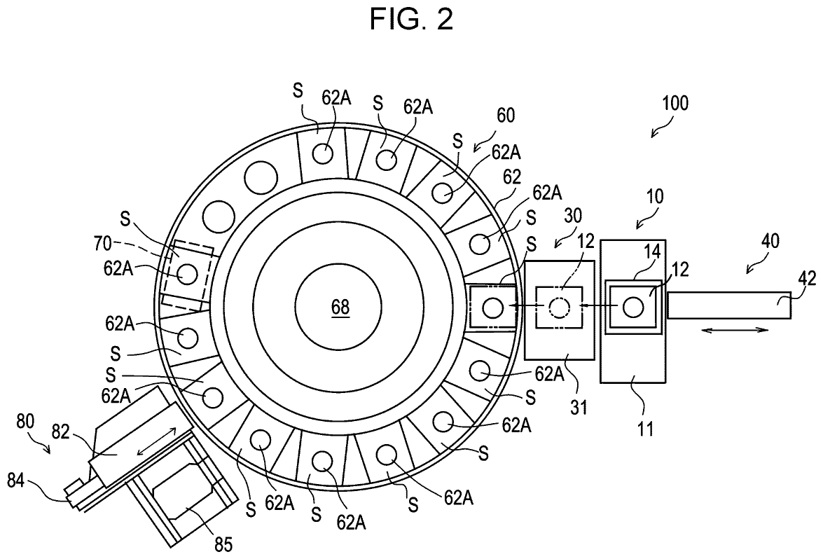

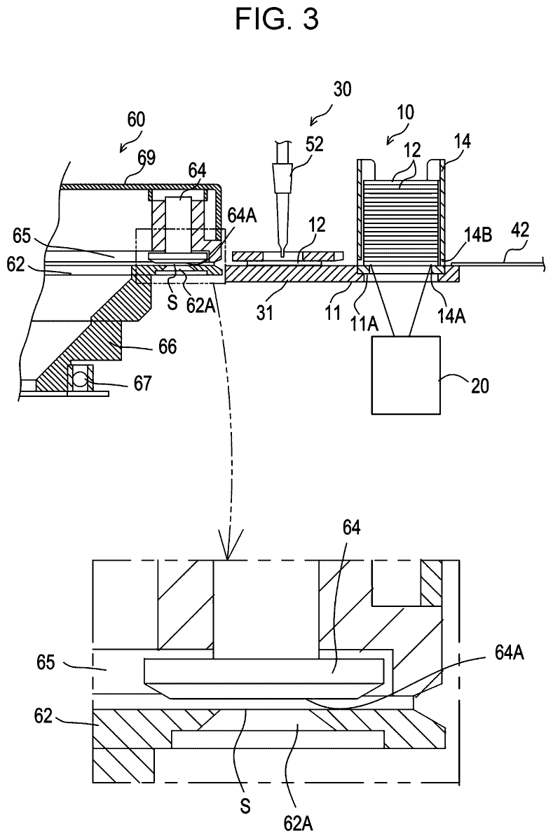

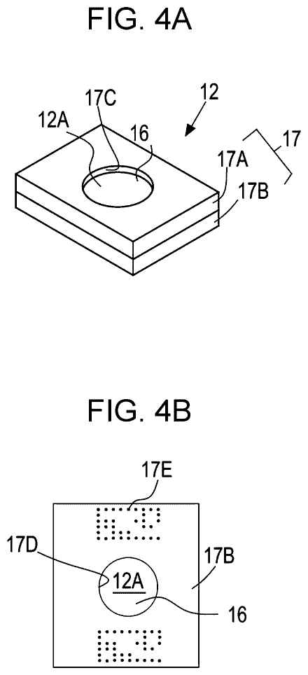

Preferred embodiments of the present disclosure will be described below with reference to the drawings. In the drawings, the same components are denoted by the same reference numerals. FIG. 1 is a schematic diagram illustrating an overall configuration of an analyzer apparatus 100 including a photometric unit 70 as an embodiment of a photometric device. FIG. 2 is a plan view of a main part of the analyzer apparatus 100 in FIG. 1, FIG. 3 is a cross-sectional view of a transportation path portion of an analytical chip, FIG. 4A is a perspective view of the analytical chip, and FIG. 4B is a plan view of a back surface of the analytical chip.

The analyzer apparatus 100 illustrated in FIG. 1 is an example of an analyzer apparatus that analyzes a test substance sample. An analytical chip 12 is detachably loaded in the analyzer apparatus 100. In the analyzer apparatus 100, for example, the concentration of a test target substance contained in the test substance sample is measured using a dry analytical chip. The analyzer apparatus 100 of the present example uses blood as the test substance sample and optically measures the concentration of a test target substance contained in the blood. More specifically, the concentration of the test target substance is measured by colorimetry.

The analyzer apparatus 100 includes a chip set section 10, a reader 20, a test substance spotting unit 30, a chip transportation mechanism 40, a test substance spotting mechanism 50, an incubator 60, the photometric unit 70, a chip discarding mechanism 80, and a control device 90.

In the chip set section 10, a stocker 14 for accommodating the analytical chip 12 is disposed on a holding table 11. A plurality of the analytical chips 12 are stacked and accommodated in the stocker 14.

The reader 20 is, for example, a code reader that reads item information given to the analytical chip 12. Thus, the type, the lot number, and/or the like of the analytical chip 12 is/are identified. The reader 20 includes, for example, an image sensor such as a charge coupled device (CCD) and a complementary metal oxide semiconductor (CMOS). The item information read by the reader 20 is output to the control device 90.

In the test substance spotting unit 30, a test substance such as blood plasma, whole blood, serum, or urine is spotted on the analytical chip 12. The test substance spotting unit 30 is provided with a chip support table 31, and spotting of the test substance sample on the analytical chip 12 transported on the chip support table 31 is performed on the chip support table 31. The spotting of the test substance sample is performed by the test substance spotting mechanism 50 described below. The chip support table 31 is disposed adjacent to the holding table 11.

As illustrated in FIG. 1 and FIG. 2, the chip transportation mechanism 40 transports the analytical chip 12 from the chip set section 10 to the test substance spotting unit 30, and further from the test substance spotting unit 30 to the incubator 60. The chip transportation mechanism 40 includes a thin plate-like chip transportation member 42, and a drive mechanism 44 that moves the chip transportation member 42 back and forth in an arrangement direction of the chip set section 10, the test substance spotting unit 30, and the incubator 60. The drive mechanism 44 is, for example, a linear actuator. The chip transportation member 42 is slidably supported by a guide rod (not illustrated) and is moved back and forth by the drive mechanism 44.

As illustrated in FIG. 1, the test substance spotting mechanism 50 includes a nozzle 52, a suction/discharge mechanism (not illustrated), and a movement mechanism that moves the nozzle 52. The test substance spotting mechanism 50 sucks a test substance sample from a test substance sample container (not illustrated) and spots the test substance sample on the analytical chip 12 in the test substance spotting unit 30.

The incubator 60 can accommodate the plurality of analytical chips 12 therein. The incubator 60 has a thermostatic function of maintaining a constant temperature in order to promote the reaction between the reagent of the analytical chip 12 and the test substance sample. The set temperature is, for example, 37° C. or the like.

As illustrated in FIG. 2, the incubator 60 includes an annular rotary substrate 62 provided with a plurality of cells S in which the analytical chip 12 is loaded. A disk-shaped holding member 65 having a pressing member 64 for pressing the analytical chip 12 loaded in the cell S in a direction toward a reactive region 12A (see FIG. 4) is provided above the rotary substrate 62. The pressing member 64 is provided corresponding to each of the plurality of cells S. As illustrated in FIG. 3, in the incubator 60, a slit-shaped space where the analytical chip 12 is loaded is formed between a pressing surface 64A of the pressing member 64 and the cell S.

A rotary cylinder 66 is provided below the rotary substrate 62. The rotary cylinder 66 has a substantially inverted triangular cross-sectional shape with the inner diameter decreasing toward the lower side. A bearing 67 is disposed below an outer circumference of the rotary cylinder 66, and the rotary cylinder 66 is rotatably supported by the bearing 67. The rotary substrate 62 rotates with the rotation of the rotary cylinder 66. The holding member 65 rotates integrally with the rotary substrate 62. The rotary cylinder 66 has an opening in a bottom portion, which is a vertex portion of the inverted triangle. This opening functions as a discarding hole 68 for discarding the used analytical chip 12. The used analytical chip 12 in a state of being loaded in the cell S is moved toward the center side of the annular rotary substrate 62, and is dropped toward the inclined surface of the rotary cylinder 66. The used analytical chip 12 dropped into the rotary cylinder 66 slides on the inclined surface and is discarded through the discarding hole 68.

The holding member 65 is provided with heating means such as a heater (not illustrated) performing temperature adjustment to constantly maintain the analytical chip 12 accommodated in the cell S at a predetermined temperature. A heat insulating cover 69 is arranged on the upper surface of the holding member 65. FIG. 2 illustrates a state where the holding member 65 and the heat insulating cover 69 are removed to expose the rotary substrate 62.

As illustrated in FIG. 2, an opening window 62A for photometry is formed at the center of the bottom surface of each cell S of the rotary substrate 62, and colorimetry for the analytical chip 12 is performed through the opening window 62A by the photometric unit 70 disposed below the rotary substrate 62.

The photometric unit 70 performs colorimetry, which is measurement for optical density using a colorimetric method, on the analytical chip 12. The photometric unit 70 is provided below the rotary substrate 62 in an outer circumference portion of the incubator 60. The photometric unit 70 acquires a detection signal indicating the optical density of the reactive region 12A of the analytical chip 12, and outputs the detection signal to the control device 90. The photometric unit 70 is an embodiment of a photometric device of the present disclosure. Details of the photometric unit 70 will be described below.

The chip discarding mechanism 80 includes a thin plate-like chip transportation member 82 and a drive mechanism 84 that moves the chip transportation member 82 back and forth. The chip discarding mechanism 80 inserts the chip transportation member 82 into the cell S from the outer circumference portion of the incubator 60, and pushes out the used analytical chip 12 after the measurement toward the central portion of the incubator 60. Thus, the analytical tip 12 is dropped into the discarding hole 68. The drive mechanism 84 is, for example, a linear actuator. The chip transportation member 82 is slidably supported by a guide rod (not illustrated) and is moved back and forth by the drive mechanism 84. A collection box for collecting the used analytical chip 12 is disposed below the discarding hole 68.

The control device 90 controls the overall operation of the analyzer apparatus 100. The configuration of the control device 90 is not particularly limited. For example, the control device 90 is realized by a computer including a processor 90A including a central processing unit (CPU), a non-volatile memory (NVM), a random access memory (RAM), and the like. The control device 90 obtains the concentration of the test target substance contained in the test substance sample based on the detection signal acquired from the photometric unit 70.

As illustrated in FIG. 4A and FIG. 4B, the analytical chip 12 has the reactive region 12A, having a flat shape, on which a reagent is immobilized. When the reagent reacts with the test target substance, a substance that develops a specific color is generated. The substance that develops the color through the reaction is hereinafter referred to as a reactant. As the reagent, for example, a dry reagent which is in a dry state at least at the time of shipment is used. The test substance sample is spotted on the reactive region 12A of the analytical chip 12.

The analytical chip 12 has a carrier 16 on which the test substance sample is spotted, and the carrier 16 is accommodated in a case 17. The case 17 includes a first case 17A and a second case 17B, and the carrier 16 is accommodated while being sandwiched between the first case 17A and the second case 17B. The first case 17A has an opening 17C formed to function as a dropping port through which the test substance sample is spotted on the reactive region 12A. An opening 17D for irradiating the reactive region 12A with light is formed in the second case 17B. The carrier 16 is exposed through the opening 17C of the first case 17A forming the front surface of the analytical chip 12. The carrier 16 is also exposed through the opening 17D of the second case 17B forming the back surface of the analytical chip 12. A region of the carrier 16 exposed through the opening 17D serves as the reactive region 12A on which the reagent is immobilized. In addition, the second case 17B is provided with an information code 17E in which item information related to a measurement item is encoded. The information code 17E is, for example, a pattern formed by a plurality of dots arranged, and the dot arrangement pattern is different among measurement items. Of course, as the information code 17E, a one-dimensional barcode, a two-dimensional barcode, or the like may be used.

By changing the reagent reacting with the test substance sample, a plurality of measurement items can be analyzed for the test substance sample. The analytical chip 12 is prepared for each measurement item, and the carrier 16 for holding a reagent corresponding to the measurement item is immobilized on the analytical chip 12. The item information provided to each analytical chip 12 includes identification information (such as reagent name and identification code) of a reagent immobilized on the carrier 16 of the analytical chip 12, identification information (such as item name and identification code) of the measurement item measured using the reagent, and the like.

As illustrated in FIG. 3, the stocker 14 has a sidewall provided with an insertion port 14B into which the chip transportation member 42 is inserted. The chip transportation member 42 is inserted into the stocker 14 through the insertion port 14B.

The stocker 14 has a bottom surface provided with an opening 14A. The analytical chip 12 accommodated is oriented to have a surface, on which the information code 17E is recorded, facing the opening 14A side of the stocker 14. Therefore, in the stocker 14, the information code 17E of the analytical chip 12 positioned at the lowest stage closest to the opening 14A is exposed through the opening 14A. The holding table 11 on which the stocker 14 is disposed is also provided with an opening 11A. Therefore, the information code 17E of the analytical chip 12 positioned at the lowest stage in the stocker 14 is exposed toward the reader 20 through the opening 11A of the holding table 11 and the opening 14A of the stocker 14. The reader 20 is disposed below the holding table 11 and reads the information code 17E exposed through the opening 11A and the opening 14A.

The chip transportation member 42 is pressed against the analytical chip 12 accommodated in the lowest stage among the analytical chips 12 stacked in the stocker 14. In this state, the chip transportation member 42 moves toward the incubator 60 side. As a result, the analytical chip 12 is transported toward the incubator 60 side.

In the incubator 60, the analytical chip 12 is loaded in the slit-shaped space formed between the cell S of the rotary substrate 62 and the pressing member 64. The analytical chip 12 is heated in the incubator 60 and is transported to a measurement position by the rotation of the incubator 60. The measurement position is a position where the photometric unit 70 is disposed below the rotary substrate 62 and the colorimetry is performed on the analytical chip 12.

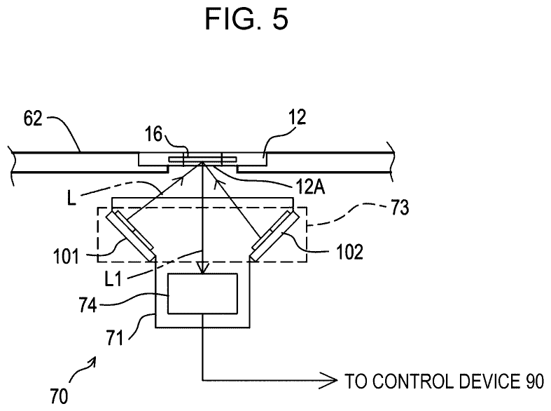

FIG. 5 is a schematic diagram illustrating a schematic configuration of the photometric unit 70 and a positional relationship of the analytical chip 12. As illustrated in FIG. 5, the photometric unit 70 includes a housing 71, an irradiation device 73 for irradiating the reactive region 12A with measurement light L, and a photodetector 74 that receives output light L1 from the reactive region 12A and performs photoelectrical conversion thereon. An optical system (not illustrated) is included in the housing 71 for collecting the output light L1 from the reactive region 12A and guiding the light to the photodetector 74.

As will be described in detail below, the irradiation device 73 includes two light-emitting element groups 101 and 102 each including a plurality of light-emitting elements. The wavelength range of the measurement light L is determined according to the test target substance (that is, measurement item). For example, in the present example, as described above, a reactant that develops a specific color is generated as a result of the reaction between the test target substance and the reagent. Since the irradiation light from the irradiation device 73 is the measurement light L for detecting whether the reactant is generated, the wavelength range is determined according to the color developed by the reactant. The measurement light L of the present example is, for example, light including a wavelength range to be absorbed by the reactant, for the detection of the reactant. The plurality of light-emitting elements included in the light-emitting element groups 101 and 102 are a plurality of light-emitting elements that emit beams of the measurement light L having wavelengths different from each other, and each light-emitting element is used according to the type of the analytical chip 12, that is, the measurement item.

The wavelength range of the measurement light Lis preferably limited to a wavelength range to be absorbed by the reactant. As the light-emitting element that emits the measurement light L, for example, a light-emitting diode (LED), an organic electro luminescence (EL), a semiconductor laser, or the like is used.

When the analytical chip 12 is irradiated with the measurement light L, the photodetector 74 detects the output light L1 output from the reactive region 12A of the analytical chip 12. The photodetector 74 is, for example, a light-receiving element such as a photodiode that outputs a detection signal corresponding to the amount of light, or an image sensor such as a CCD camera or a CMOS camera. The photodetector 74 outputs the detection signal to the control device 90 (see FIG. 1).

The analysis in the analyzer apparatus 100 is performed as follows.

First, the analytical chip 12 is taken out from the stocker 14 by the chip transportation mechanism 40, and then transported to a spotting position on the chip support table 31. At the spotting position, the test substance is spotted on the analytical chip 12 by the test substance spotting unit 30. After the spotting on the analytical chip 12, the analytical chip 12 is transported into the incubator 60.

After the analytical chip 12 is transported into the incubator 60, the analytical chip 12 is heated by heat generated by heating means (not illustrated) in the incubator 60.

The analytical chip 12 as the measurement target is transported to the measurement position where the photometric unit 70 is provided, by the rotation of the rotary substrate 62. At the measurement position, the colorimetric measurement is performed on the analytical chip 12. The photometric unit 70 irradiates the analytical chip 12 with the measurement light L and receives the output light L1 output from the analytical chip 12 to measure an optical density corresponding to a state of reaction between the test substance sample and the reagent in the analytical chip 12, and outputs the detection signal. The control device 90 obtains the concentration of the test target substance from the detection signal acquired from the photometric unit 70.

In the reactive region 12A, the test substance sample and the reagents react with each other. As a result, the reactant that develops a specific color is generated. Due to the generation of the reactant, the color of the reactive region 12A changes, and this color change appears as a change in the optical density of the reactive region 12A. The output light L1 is light corresponding to the optical density of the reactive region 12A, and the output light L1 reflects information of the reactant as a result of absorption of light by the reactant or the like. The optical density of the reactive region 12A changes according to the amount of the reactant, and the amount of the reactant represents the concentration of the test target substance in the test substance sample. Therefore, the concentration of the test target substance can be measured based on the detection signal indicating the output light including the information of the reactant.

After the measurement is completed, the analytical chip 12 is transported by the rotary substrate 62 to a position where the chip discarding mechanism 80 is disposed. Thereafter, the analytical chip 12 is transported by the chip discarding mechanism 80 (see FIG. 2) from the inside of the incubator 60 to a discarding position provided at the central portion of the rotary substrate 62. The chip transportation member 82 pushes out the analytical chip 12, to move the analytical chip 12 from the inside of the incubator 60 to the discarding hole 68.

Hereinafter, the irradiation device 73 included in the photometric unit 70 which is an embodiment of the photometric device of the present disclosure will be described in detail. The irradiation device 73 is an embodiment of an irradiation device of the present disclosure.

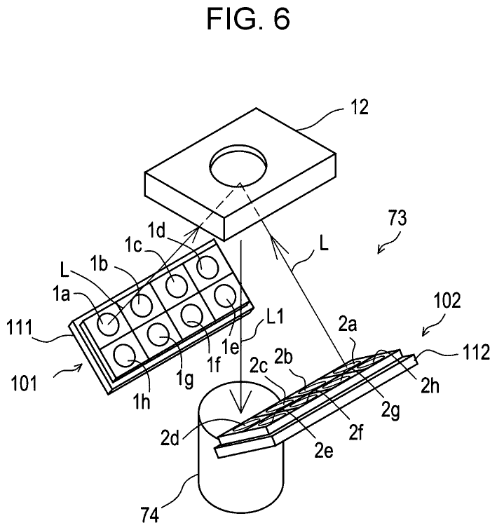

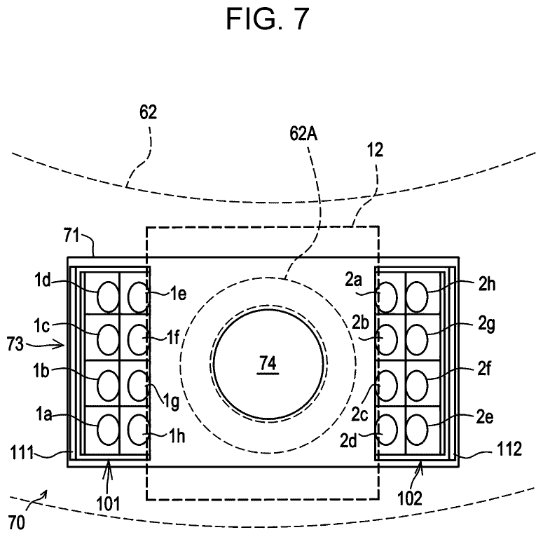

As described with reference to FIG. 5, the irradiation device 73 includes the two light-emitting element groups 101 and 102. Hereinafter, one of the two light-emitting element groups 101 and 102 is referred to as a first light-emitting element group 101, and the other is referred to as a second light-emitting element group 102. FIG. 6 is a perspective view illustrating a positional relationship among the analytical chip 12, the first light-emitting element group 101, the second light-emitting element group 102, and the photodetector 74 illustrated in FIG. 5. FIG. 7 is a plan view of the irradiation device 73 and the photodetector 74 as viewed from the rotary substrate 62 side.

As illustrated in FIG. 6, the first light-emitting element group 101 includes eight light-emitting elements 1a to 1h on a support substrate 111, and the second light-emitting element group 102 includes eight light-emitting elements 2a to 2h on a support substrate 112. As illustrated in the plan view of FIG. 7, the first light-emitting element group 101 and the second light-emitting element group 102 are disposed opposite to each other with the photodetector 74 interposed therebetween. The first light-emitting element group 101 and the second light-emitting element group 102 are disposed with the respective support substrates 111 and 112 inclined with respect to the normal line of the analytical chip 12 (the Z axis described below). Note that the inclination angle of the support substrate 112 of the first light-emitting element group 101 with respect to the XY plane is the same as the inclination angle of the support substrate 111 of the second light-emitting element group 102 with respect to the XY plane. That is, the support substrate 111 and the support substrate 112 are disposed symmetrically with respect to the Z axis. The light-emitting surfaces of the light-emitting elements 1a to 1h and 2a to 2h are substantially parallel to the surfaces of the respective support substrates 111 and 112 on which the light-emitting elements are provided. On each of the support substrates 111 and 112, the eight light-emitting elements 1a to 1h, 2a to 2h are arranged in two rows. On the support substrate 111, the light-emitting elements 1a, 1b, 1c, and 1d are arranged on the first row, on the rotary substrate 62 side, in this order from the outer circumference side of the rotary substrate 62, and the light-emitting elements 1e, 1f, 1g, and 1h are arranged on the second row in this order from the inner circumference side of the rotary substrate 62. On the other hand, on the support substrate 112, 2e, 2f, 2g, and 2h are arranged on the first row, on the rotary substrate 62 side, in this order from the outer circumference side of the rotary substrate 62, and 2a, 2b, 2c, and 2d are arranged on the second row in this order from the inner circumference side of the rotary substrate 62.

The eight light-emitting elements 1a to 1h of the first light-emitting element group 101 emit light in different wavelength ranges. Similarly, the eight light-emitting elements 2a to 2h of the second light-emitting element group 102 emit light in different wavelength ranges. Hereinafter, the light-emitting elements of the first light-emitting element group 101 are referred to as first light-emitting elements 1a, 1b, 1c, . . . , and the light-emitting elements of the second light-emitting element group 102 are referred to as second light-emitting elements 2a, 2b, 2c, . . . . Those with the same letter at the end, such as the first light-emitting element 1a and the second light-emitting element 2a, as well as the light-emitting element 1b and the light-emitting element 2b emit light in the same wavelength range. That is, the irradiation device 73 includes eight pairs of light-emitting elements that emit light of the same wavelength. It should be noted that the light in the same wavelength range refers to beams of light whose peak wavelengths match within a range of ±5 nm and beams of light whose wavelengths match within a range of ±5 nm are referred to as light of the same wavelength.

At the time of measurement of one analytical chip 12, one light-emitting element pair including two light-emitting elements of the same wavelength corresponding to the analytical chip 12 is selectively used among the light-emitting elements 1a to 1h of the first light-emitting element group 101 and the light-emitting elements 2a to 2h of the second light-emitting element group 102.

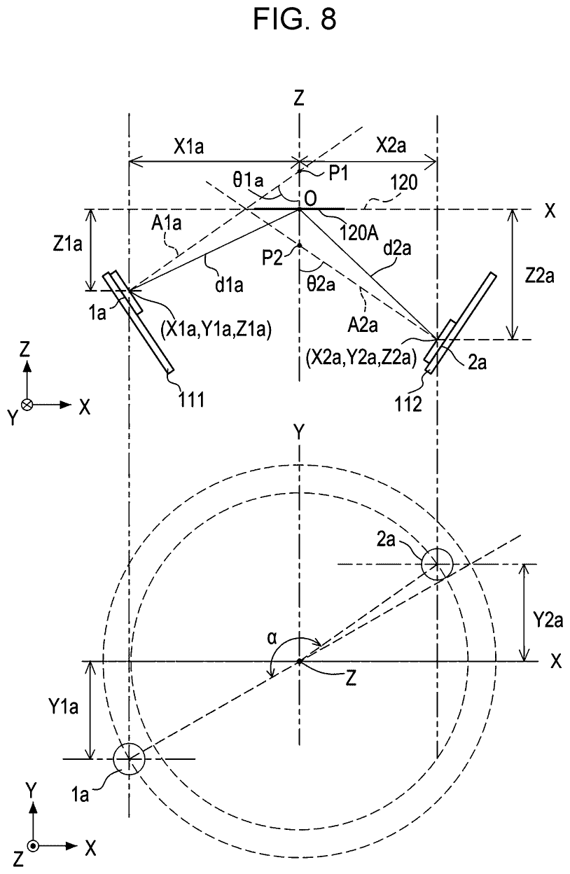

The relative positional relationship between light-emitting elements of the same wavelength will be described. Hereinafter, a relative positional relationship between the first light-emitting element 1a included in the first light-emitting element group 101 and the second light-emitting element 2a included in the second light-emitting element group 102, as a light-emitting element pair, will be described as an example. FIG. 8 is a diagram illustrating a positional relationship between a measurement reference plane 120 and the first light-emitting element 1a and the second light-emitting element 2a.

Here, the normal direction of the reactive region 12A of the analytical chip 12 properly loaded at the load position is defined as the Z axis, and the plane including the reactive region 12A is defined as the XY plane. The center of the reactive region 12A in the XY plane is defined as an origin O. The state in which the analytical chip 12 is properly loaded at the load position means a state in which the reactive region 12A of the analytical chip 12 is positioned on the designed measurement plane. The designed measurement plane is referred to as the measurement reference plane 120. The measurement reference plane 120 coincides with the XY plane. A region of the measurement reference plane 120 corresponding to the reactive region 12A is referred to as a measurement reference region 120A. Hereinafter, a plane including the reactive region 12A in the state where the analytical chip 12 is actually loaded is referred to as a measurement plane. A straight line extending in the normal direction of the light-emitting surface from the light emission center matching the peak of the light intensity distribution in the light-emitting surface of each of the light-emitting elements 1a to 1h and 2a to 2h is defined as the light emission center axis. Hereinafter, the light emission center axis of the first light-emitting element 1a is denoted by Ala, and the light emission center axis of the second light-emitting element 2a is denoted by A2a.

The relative positional relationship between the first light-emitting element 1a and the second light-emitting element 2a satisfies the following first condition and second condition. The first condition relates to a relative positional relationship between the first light-emitting element 1a and the second light-emitting element 2a in the circumferential direction around the Z axis. The first condition is a condition satisfied when the first light-emitting element 1a and the second light-emitting element 2a are arranged at an interval of 90° or more and 180° or less as a central angle α around the Z axis. Angles such as the central angle include a tolerance of about ±5°.

In the present example, as illustrated in the lower drawing of FIG. 8, the central angle α between the first light-emitting element 1a and the second light-emitting element 2a is slightly smaller than 180°. Any arrangement may be employed as long as the central angle α between the first light-emitting element 1a and the second light-emitting element 2a is 90° or more. Still, for the sake of averaging the amount of illumination light over the entire reactive region 12A, the central angle α closer to 180° is more preferable, and the central angle α of 180° is most preferable.

The second condition relates to a first intersection P1, which is an intersection between the Z axis and the first light emission center axis Ala of the first light-emitting element 1a, and a second intersection P2, which is an intersection between the Z axis and the second light emission center axis A2a of the second light-emitting element 2a. The second condition is a condition satisfied when one of the first intersection P1 and the second intersection P2 is located in the positive direction and the other is located in the negative direction, with the positive direction and the negative direction respectively being on one side and the other side on the Z axis with respect to the XY plane.

As illustrated in the upper drawing of FIG. 8, in the present embodiment, the first intersection P1 where the first light emission center axis Ala of the first light-emitting element 1a intersects the Z axis is located in the positive direction of the Z axis from the origin O, and the second intersection P2 where the second light emission center axis A2a of the second light-emitting element 2a intersects the Z axis is located in the negative direction of the Z axis from the origin O.

The first light-emitting element 1a and the second light-emitting element 2a are arranged at an interval corresponding to the central angle α of 90° or more and 180° or less around the Z axis. With this configuration, when the first light-emitting element 1a and the second light-emitting element 2a emit light of the same wavelength, it is possible to suppress unevenness in the amount of illumination light in the reactive region 12A. Further, since the first light emission center axis Ala of the first light-emitting element 1a and the second light emission center axis A2a of the second light-emitting element 2a are arranged so as to intersect each other while being deviated from the XY plane in the positive direction and the negative direction along the Z axis, even when the actual measurement plane is slightly deviated from the measurement reference plane 120 in the Z direction, it is possible to suppress a variation in the amount of illumination light emitted to the reactive region 12A.

In the present embodiment, two light-emitting elements, that is, the first light-emitting element 1a and the second light-emitting element 2a emit light of the same wavelength, but there may be three or more such light-emitting elements. When there are three or more light-emitting elements, as long as two of the light-emitting elements serve as the first light-emitting element 1a and the second light-emitting element 2a and satisfy the above relationship, the arrangement of the other light-emitting elements is not limited. Still, as described above, with the two light-emitting elements, the unevenness in the amount of illumination light in the measurement plane can be suppressed, and the variation in the amount of illumination light can be suppressed when the measurement plane is deviated from the measurement reference plane 120 in the normal direction. Therefore, two light-emitting elements are most preferable for the sake of cost suppression. With only two light-emitting elements that emit light of the same wavelength provided, it is possible to suppress an increase in size of the irradiation device 73 and to realize downsizing. For example, as illustrated in FIG. 7, the irradiation device 73 can have a rectangular shape with longitudinal direction extending along the tangential direction of the circle of the rotary substrate 62. Since the irradiation device 73 can have a rectangular shape, the maximum width of the housing 71 of the photometric unit 70 can be configured to be equal to the length of the irradiation device 73 in the longitudinal direction. In the analyzer apparatus 100 of the present embodiment, the rotary cylinder 66 having a center portion provided with the discarding hole 68 for discarding the analytical chip 12 is provided below the rotary substrate 62 (see FIG. 1). To prevent interference with the rotary cylinder 66, the irradiation device 73 and the photometric unit 70 having a rectangular shape in plan view without protruding toward the inner diameter side of the annular rotary substrate 62 are suitable for the analyzer apparatus 100.

The absolute values of the Z coordinate of the first intersection P1 and the Z coordinate of the second intersection P2 are preferably the same. That is, a distance to the first intersection P1 from the XY plane is preferably the same as a distance to the second intersection P2 from the XY plane. These distances may not necessarily be the same, but with the distances being the same, the level of matching between the irradiation regions in the measurement plane is improved, unevenness in the amount of in-plane illumination light is suppressed, and higher uniformity can be achieved.

As described above, in the irradiation device 73 of the present embodiment, the inclination angle of the first light-emitting element group 101 with respect to the XY plane of the support substrate 111 is the same as the inclination angle of the second light-emitting element group 102 with respect to the XY plane of the support substrate 112. The light-emitting surfaces of the light-emitting elements 1a to 1h and 2a to 2h are substantially parallel to the surfaces of the respective support substrates 111 and 112 on which the light-emitting elements are provided. That is, the inclination angle of the first light-emitting element 1a with respect to the XY plane is equal to the inclination angle of the second light-emitting element 2a with respect to the XY plane. Therefore, as illustrated in FIG. 8, an angle θ1a between the first light emission center axis Ala perpendicular to the light-emitting surface of the first light-emitting element 1a and the Z axis perpendicular to the XY plane is equal to an angle θ2a between the second light emission center axis A2a perpendicular to the light-emitting surface of the second light-emitting element 2a and the Z axis perpendicular to the XY plane.

On the other hand, the Z coordinates indicating the distances from the XY plane to the first light-emitting element 1a and the second light-emitting element 2a are different from each other. In the present embodiment, a Z coordinate Z1a of the first light-emitting element 1a and a Z coordinate Z2a of the second light-emitting element 2a satisfy a relationship |Z2a|>|Z1a|≠0.

Thus, the first intersection P1 and the second intersection P2 can be shifted by changing the positions in the Z axis direction with the installation inclination being the same between the first light-emitting element 1a and the second light-emitting element 2a, whereby a configuration in which one of the first intersection P1 and the second intersection P2 is positioned on the positive side of the Z axis and the other is positioned on the negative side can be easily realized.

The configuration in which one of the first intersection P1 and the second intersection P2 is positioned in the positive direction on the Z axis and the other is positioned in the negative direction can also be realized with the angle between the light-emitting surface of the first light-emitting element 1a and the XY plane being different from the angle between the light-emitting surface of the second light-emitting element 2a and the XY plane, that is, with the inclination being different between the first light-emitting element 1a and the second light-emitting element 2a installed. Still, preferably, the position in the Z axis direction is changed with the inclination being the same between the first light-emitting element 1a and the second light-emitting element 2a installed as in the present example, so that a simple installation configuration can be achieved to suppress increase in cost.

As illustrated in FIG. 8, the following formula is preferably satisfied where (X1a, Y1a, Z1a) represents the coordinates indicating the position of the first light-emitting element 1a, and (X2a, Y2a, Z2a) represents the coordinates indicating the position of the second light-emitting element 2a.

$$\sqrt{X 1 {a}^{2} + Y 1 {a}^{2} + Z 1 {a}^{2}} = \sqrt{X 2 {a}^{2} + Y 2 {a}^{2} + Z 2 {a}^{2}}$$

Here, the coordinates of the light-emitting element are the coordinates of the center of the light-emitting surface.

When the above formula is satisfied, it means that a distance d1a to the origin O from the first light-emitting element 1a and a distance d2a to the origin O from the second light-emitting element 2a are the same. When the above formula is satisfied, the amount of illumination light from the first light-emitting element 1a and the amount of illumination light from the second light-emitting element 2a can be made substantially the same on the measurement reference plane 120. Therefore, unevenness in the amount of illumination light on the measurement reference plane 120 can be suppressed and the amount of illumination light can be uniformized. Further, when the above formula is satisfied, it is possible to improve the effect of suppressing variation in the amount of illumination light when the measurement plane is deviated from the measurement reference plane 120 in the Z axis direction.

While the relationship between the first light-emitting element 1a and the second light-emitting element 2a among the eight pairs of light-emitting elements in the irradiation device 73 is described above, the same relationship is preferably satisfied with each of the other light-emitting element pairs. Specifically, the following formula is preferably satisfied where (X1, Y1, Z1) represents the coordinates indicating the position of the first light-emitting element in each light-emitting element pair, and (X2, Y2, Z2) represents the coordinates indicating the position of the second light-emitting element in each light-emitting element pair.

$$\sqrt{X {1}^{2} + Y {1}^{2} + Z {1}^{2}} = \sqrt{X {2}^{2} + Y {2}^{2} + Z {2}^{2}}$$

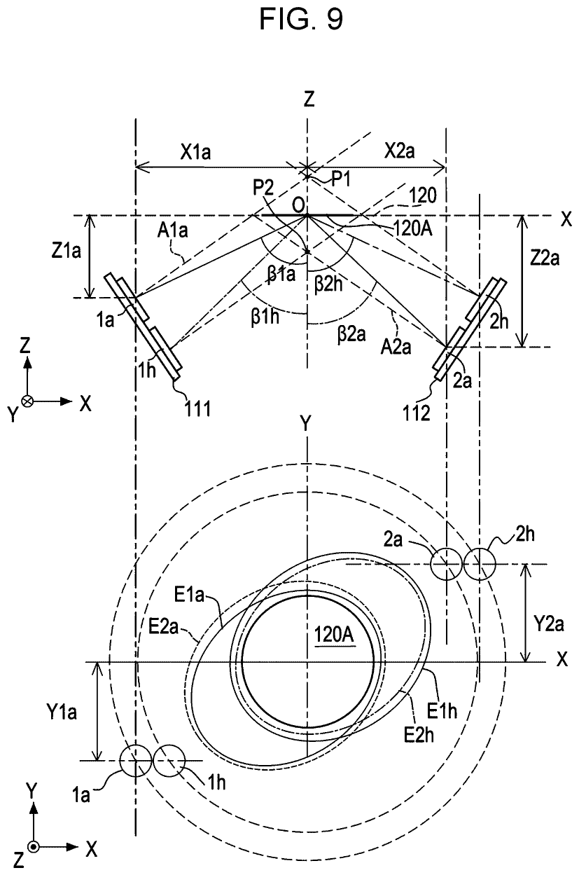

FIG. 9 is a diagram illustrating a positional relationship between the measurement reference plane 120, the first light-emitting element pair including the first light-emitting element 1a and the second light-emitting element 2a, and the second light-emitting element pair including the first light-emitting element 1h and the second light-emitting element 2h. In the present embodiment, as illustrated in FIG. 9, the sum β1a+β2a of a first inclination angle β1a between the straight line connecting the center of the first light-emitting element 1a to the origin O and the Z axis, and a second inclination angle β2a between the straight line connecting the center of the second light-emitting element 2a to the origin O and the Z axis is equal to the sum β1h+β2h of a first inclination angle β1h between the straight line connecting the center of the first light-emitting element 1h to the origin O and the Z axis and a second inclination angle β2h between the straight line connecting the center of the second light-emitting element 2h to the origin O and the Z axis (β1a+β2a=β1h+β2h). Here, the center of the light-emitting element is assumed to be the center of the light-emitting surface of the light-emitting element. Note that, in the present embodiment, light-emitting element pairs other than the first light-emitting element pair and the second light-emitting element pair satisfy the same relationship.

In the present embodiment, the first inclination angle β1a of the first light-emitting element 1a of the first light-emitting element pair is equal to the second inclination angle β2h of the second light-emitting element 2h of the second light-emitting element pair, and the second inclination angle β2a of the second light-emitting element 2a of the first light-emitting element pair is equal to the first inclination angle β1h of the first light-emitting element 1h of the second light-emitting element pair (β1a=β2h, β2a=β1h). The first light-emitting elements 1a to 1h are provided on one support substrate 111, and the second light-emitting elements 2a to 2h are provided on one support substrate 112.

When the angles formed by the light-emitting surfaces of the light-emitting elements and the XY plane are the same, a longer distance to the light-emitting element from the XY plane (a larger absolute value of the Z coordinate) leads to a larger illumination region in the XY plane, and lower illumination light density in the reactive region 12A. On the other hand, a shorter distance to the light-emitting element from the XY plane (a smaller absolute value of the Z coordinate) leads to a smaller illumination region in the XY plane becomes, and higher illumination light density in the reactive region 12A. As in the present embodiment, when the distances to the origin O from the first light-emitting element 1a and the second light-emitting element 2a in the first light-emitting element pair are the same, the distances to the origin O from the first light-emitting element 1h and the second light-emitting element 2h in the second light-emitting element pair are the same, and β1a+β2a=β1h+β2h holds, the amount of illumination light in the region where the illumination regions of the two light-emitting elements 1a and 2a of the first light-emitting element pair overlap can be made substantially equal to the amount of illumination light in the region where the illumination region of the two light-emitting elements 1h and 2h of the second light-emitting element pair overlap.

The lower drawing of FIG. 9 illustrates an irradiation region Ela, in the XY plane, irradiated with the irradiation light from the first light-emitting element 1a and an irradiation region E2a, in the XY plane, irradiated with the irradiation light from the second light-emitting element 2a. The irradiation region Ela and the irradiation region E2a overlap with each other over substantially the entire region. Since |Z1a|<|Z2a| holds, E1a<E2a holds. The lower drawing of FIG. 9 illustrates an irradiation region E1h, in the XY plane, irradiated with the irradiation light from the first light-emitting element 1h and an irradiation region E2h, in the XY plane, irradiated with the irradiation light from the second light-emitting element 2h. The irradiation region E1h and the irradiation region E2h overlap with each other over substantially the entire region. Since |Z1h|>|Z2h| holds, E1h>E2h holds. The irradiation regions Ela and E2a of the first light-emitting element pair and the irradiation regions E1h and E2h of the second light-emitting element pair are shifted from each other in the XY plane, and each include the measurement reference plane 120. At least the amount of illumination light from the first light-emitting element pair and the amount of illumination light from the second light-emitting element pair are the same on the measurement reference plane 120.

The irradiation device 73 of the present embodiment includes eight light-emitting element pairs, but the irradiation device of the present disclosure may include only one light-emitting element pair.

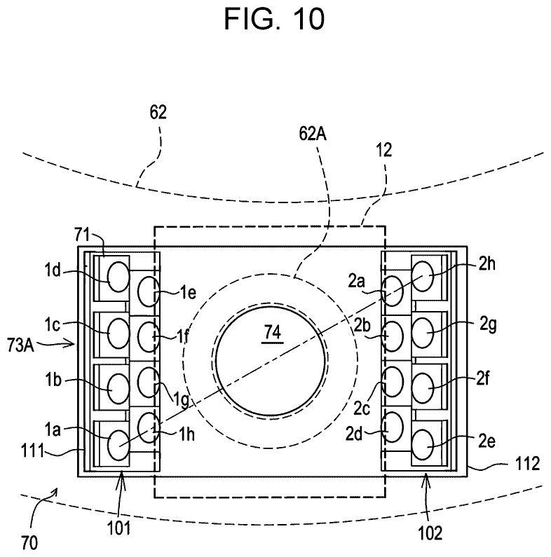

The irradiation device 73 includes eight light-emitting elements 1a to 1h and 2a to 2h arranged in a two-row matrix respectively on the rectangular support substrates 111 and 112. Therefore, the central angle α between the light-emitting elements paired is slightly smaller than 180°. On the other hand, as in an irradiation device 73A of a modification illustrated in FIG. 10, the central angle α between the light-emitting elements paired can be set to 180° by arranging the light-emitting elements 1a to 1d and 2e to 2h, respectively in the first rows of the support substrates 111 and 112, with gaps in between. When the central angle α is 180°, the first light emission center axis and the second light emission center axis of each light-emitting element pair intersect at a position separated from the origin O by a predetermined distance on the measurement reference plane 120.

### <Simulation>

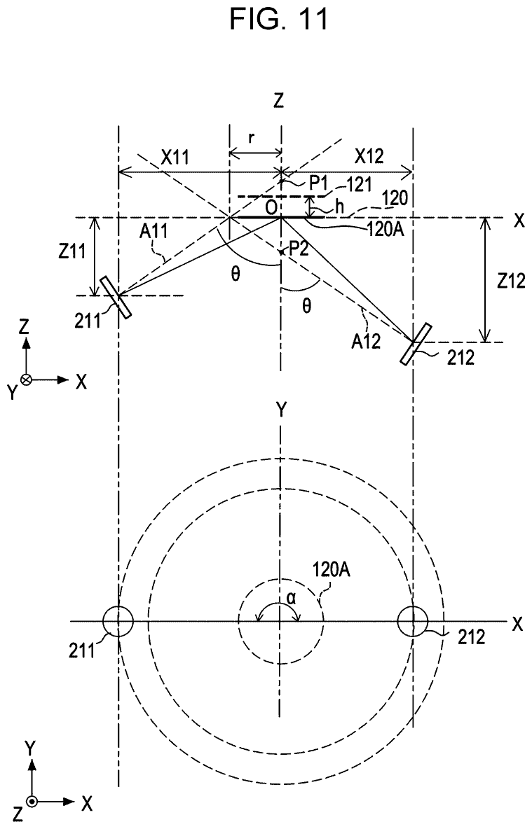

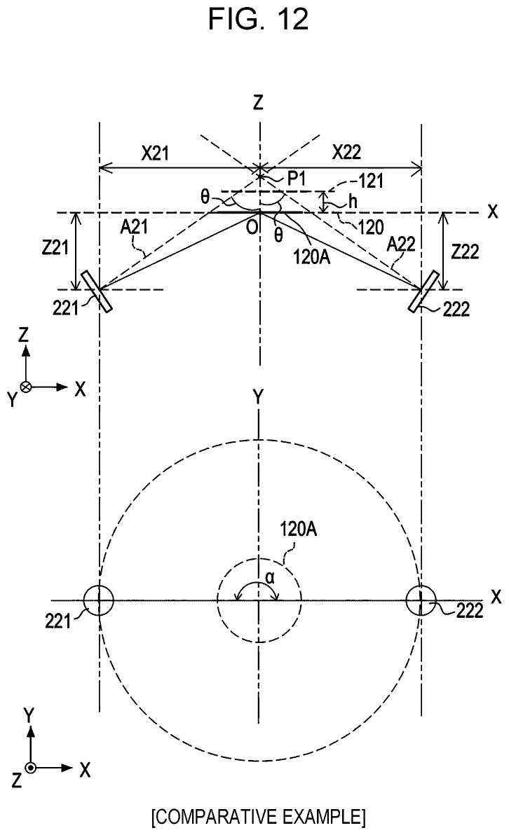

Using an irradiation device of a configuration example of the present disclosure and an irradiation device of a comparative example, a simulation was performed related to a variation in the light irradiation amount on the light irradiation surface, with the measurement plane deviated from the measurement reference plane 120 in the vertical direction. Light-emitting elements are assumed to be LEDs. FIG. 11 illustrates an arrangement of a first light-emitting element 211 and a second light-emitting element 212 with respect to the measurement reference region 120A of the measurement reference plane 120 according to the configuration example, and FIG. 12 illustrates an arrangement of a first light-emitting element 221 and a second light-emitting element 222 with respect to the measurement reference region 120A according to the comparative example. In FIG. 11 and FIG. 12, the measurement reference plane 120 is the XY plane, the center of the measurement reference region 120A is the origin O, and the Z axis passes through the origin O and extends in the normal direction of the measurement reference plane 120.

### Configuration Example

As illustrated in FIG. 11, according to the configuration example, the first light-emitting element 211 and the second light-emitting element 212 are arranged on the X axis. That is, the Y coordinates of the first light-emitting element 211 and the second light-emitting element 212 are both 0, and the central angle α is 180°. The coordinates of the first light-emitting element 211 are (X11, 0, Z11), and the coordinates of the second light-emitting element 212 are (X12, 0, Z12). Here, |X11|>|X12| and |Z11|<|Z12| hold. As illustrated in FIG. 11, the first intersection P1 between a light emission center axis A11 of the first light-emitting element 211 and the Z axis is located on the positive side of the Z axis, and the second intersection P2 between a light emission center axis A12 of the second light-emitting element 212 and the Z axis is located on the negative side of the Z axis. In this case, the light emission center axis A11 and the light emission center axis A12 intersect each other at a position separated from the origin O on the measurement reference plane 120 by a distance r. An inclination angle θ of the light emission center axis A11 of the first light-emitting element 211 with respect to the Z axis is the same as an inclination angle θ of the light emission center axis A12 of the second light-emitting element 212 with respect to the Z axis, and is set to 50° herein. In the simulation, X11 was set to 20.7 mm, X12 was set to 18.3 mm, Z11 was set to 13.7 mm, and Z12 was set to 16.8 mm.

### Comparative Example

As illustrated in FIG. 12, also in the comparative example, the first light-emitting element 211 and the second light-emitting element 212 are arranged on the X axis. That is, as in the configuration example, their Y coordinates are both 0, and the central angle α is 180°. The first light-emitting element 221 and the second light-emitting element 222 are arranged symmetrically with respect to the Z axis. Assuming that the coordinates of the first light-emitting element 221 are (X21, 0, Z21) and the coordinates of the second light-emitting element 222 are (X22, 0, Z22), |X21|=|X22| and |Z21|=|Z22| hold. As illustrated in FIG. 12, a light emission center axis A21 of the first light-emitting element 221 and a light emission center axis A22 of the second light-emitting element 222 intersect at a position P on the positive side on the Z axis. An inclination angle θ of the light emission center axis A21 of the first light-emitting element 221 with respect to the Z axis is the same as an inclination angle θ of the light emission center axis A22 of the second light-emitting element 222 with respect to the Z axis, and is 50° as in Configuration Example. In the simulation, X21 was set to be the same as X22 and to 20.7 mm and Z21 was set to be the same as Z22 and to 13.7 mm.

In the configuration example and the comparative example, the directional characteristics of the LEDs as the light-emitting elements were assumed to be ±60° and the size of a measurement plane 121 is assumed to be 8 mm×8 mm.

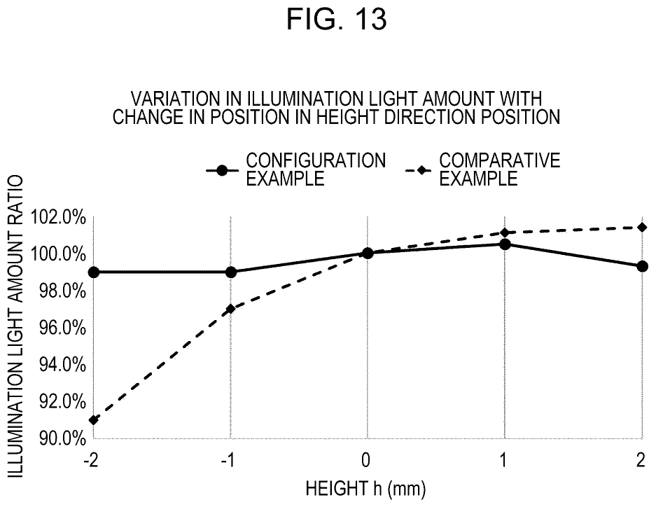

For each of the configuration example and the comparative example, the amount of illumination light on the measurement plane 121 was obtained through the simulation, with the positional shift (height h from the origin) of the measurement plane 121 from the measurement reference plane 120 changed among −2, −1, 0, 1, and 2 (mm). The amount of illumination light obtained through the simulation is a total value of the amounts of illumination light on the entire measurement plane 121 of the 8 mm×8 mm size. Table 1 illustrates an illumination light amount ratio at each position with the amount of illumination light at the measurement reference plane h=0 defined as 100%. FIG. 13 is a graph of the variation in the amount of illumination light in the configuration example and the comparative example, with the lateral axis and the vertical axis respectively representing the height h and the illumination light amount ratio in Table 1.

TABLE 1

| DEVIATION FROM REFERENCE | CONFIGURA- | |
|---|---|---|
| MEASUREMENT PLANE | TION | COMPARATIVE |
| HEIGHT h (mm) | EXAMPLE | EXAMPLE |
| −2 | 99.0% | 91.0% |
| −1 | 99.0% | 97.0% |
| 0 | 100.0% | 100.0% |
| 1 | 100.5% | 101.1% |
| 2 | 99.3% | 101.4% |
| ILLUMINATION LIGHT AMOUNT | 1.5% | 10.4% |
| VARIATION AMOUNT Δ | | |
| (MAXIMUM VALUE − MINIMUM | | |
| VALUE) | | |

As illustrated in Table 1 and FIG. 13, while the amount of variation in the amount of illumination light in the comparative example exceeded 10% in the range of ±2 mm, the amount of variation in the amount of illumination light in the configuration example was 1.5%. Thus, the results obtained indicate that the variation in the amount of illumination light can be significantly suppressed in the configuration example. In other words, the results indicate that significant improvement can be achieved for the variation in the amount of illumination light by arranging the two light-emitting elements with one of the intersections P1 and P2 between the light emission center axes and the Z axis being on the positive side and the other being on the negative side of the Z axis of the reference measurement plane.

With respect to the above embodiments, the following appendices are further disclosed.

### APPENDIX 1

An irradiation device configured to irradiate a planar reactive region of an analytical chip with light when optically analyzing a test substance sample by using the analytical chip having the reactive region in which a reagent reacting with a test target substance contained in the test substance sample is immobilized, the irradiation device including
at least two light-emitting elements including a first light-emitting element and a second light-emitting element as light-emitting elements configured to emit light in a same wavelength range, wherein
a relative positional relationship between the first light-emitting element and the second light-emitting element satisfies a first condition and a second condition below, where a normal direction of the reactive region of the analytical chip in a state of being properly loaded at a load position is defined as a Z axis, a plane including the reactive region is defined as an XY plane, and a straight line extending in a normal direction of a light-emitting surface of the light-emitting elements from a light emission center matching a peak of light intensity distribution in the light-emitting surface is defined as a light emission center axis,
the first condition relates to a relative positional relationship between the first light-emitting element and the second light-emitting element in a circumferential direction around the Z axis, and is a condition satisfied when the first light-emitting element and the second light-emitting element are arranged at an interval of 90° or more and 180° or less as a central angle around the Z axis, and
the second condition is a condition satisfied when one of a first intersection and a second intersection is located in a positive direction and another one of the first intersection and the second intersection is located in a negative direction, where the first intersection is an intersection between a first light emission center axis of the first light-emitting element and the Z axis, the second intersection is an intersection between a second light emission center axis of the second light-emitting element and the Z axis, and the positive direction and the negative direction are respectively on one side and another side on the Z axis with respect to the XY plane.

### APPENDIX 2

The irradiation device according to appendix 1, wherein a distance to the first intersection from the XY plane is equal to a distance to the second intersection from the XY plane.

### APPENDIX 3

The irradiation device according to appendix 1 or appendix 2, wherein the central angle is 180°.

### APPENDIX 4

The irradiation device according to any one of appendix 1 to appendix 3, wherein an angle formed by the light-emitting surface of the first light-emitting element and the XY plane is equal to an angle formed by the light-emitting surface of the second light-emitting element and the XY plane, and
the first light-emitting element and the second light-emitting element have different Z coordinates.

### APPENDIX 5

The irradiation device according to appendix 4, wherein

$$\sqrt{X {1}^{2} + Y {1}^{2} + Z {1}^{2}} = \sqrt{X {2}^{2} + Y {2}^{2} + Z {2}^{2}}$$

is satisfied, where an origin is a center of the reactive region of the analytical chip in a state of being properly loaded at the load position, X1, Y1, and Z1 denote a position of the first light-emitting element, and X2, Y2, and Z2 denote a position of the second light-emitting element.

### APPENDIX 6

The irradiation device according to any one of appendix 1 to appendix 5, including a plurality of light-emitting element pairs each including a set of the first light-emitting element and the second light-emitting element, the light-emitting element pairs being different from each other in wavelength range.

### APPENDIX 7

The irradiation device according to any one of appendix 1 to appendix 5, including a plurality of light-emitting element pairs each including a set of the first light-emitting element and the second light-emitting element, the light-emitting element pairs being different from each other in wavelength range, wherein
a sum of a first inclination angle between a straight line connecting a center of the first light-emitting element to the origin and the Z axis and a second inclination angle between a straight line connecting a center of the second light-emitting element to the origin and the Z axis is same between at least two light-emitting element pairs among the plurality of light-emitting element pairs.

### APPENDIX 8

The irradiation device according to appendix 7, wherein the first inclination angle and the second inclination angle of one of the two light-emitting element pairs are same as one of the first inclination angle and the second inclination angle of another one of the two light-emitting element pairs.

### APPENDIX 9

The irradiation device according to any one of appendix 1 to appendix 8, wherein the light-emitting elements are light-emitting diodes.

### APPENDIX 10

A photometric device configured to optically analyze a test substance sample by using an analytical chip having a reactive region where a reagent reacting with a test target substance is immobilized, the photometric device including:
the irradiation device according to any one of appendix 1 to appendix 9; and
a photodetector configured to detect output light output from the analytical chip when the analytical chip is irradiated with the light and output a detection signal corresponding to the output light.

The disclosure of JP2023-019490 filed on Feb. 10, 2023 is incorporated herein by reference in its entirety. All publications, patent applications, and technical standards mentioned in this specification are herein incorporated by reference to the same extent as if each individual publication, patent application, or technical standard is specifically and individually indicated to be incorporated by reference.

What is claimed is:

1. An irradiation device configured to irradiate a planar reactive region of an analytical chip with light when optically analyzing a test substance sample by using the analytical chip having the reactive region in which a reagent reacting with a test target substance contained in the test substance sample is immobilized, the irradiation device comprising
at least two light-emitting elements including a first light-emitting element and a second light-emitting element as light-emitting elements configured to emit light in a same wavelength range, wherein
a relative positional relationship between the first light-emitting element and the second light-emitting element satisfies a first condition and a second condition below, where a normal direction of the reactive region of the analytical chip in a state of being properly loaded at a load position is defined as a Z axis, a plane including the reactive region is defined as an XY plane, and a straight line extending in a normal direction of a light-emitting surface of the light-emitting elements from a light emission center matching a peak of light intensity distribution in the light-emitting surface is defined as a light emission center axis,
the first condition relates to a relative positional relationship between the first light-emitting element and the second light-emitting element in a circumferential direction around the Z axis, and is a condition satisfied when the first light-emitting element and the second light-emitting element are arranged at an interval of 90° or more and 180° or less as a central angle around the Z axis, and
the second condition is a condition satisfied when one of a first intersection and a second intersection is located in a positive direction and another one of the first intersection and the second intersection is located in a negative direction, where the first intersection is an intersection between a first light emission center axis of the first light-emitting element and the Z axis, the second intersection is an intersection between a second light emission center axis of the second light-emitting element and the Z axis, and the positive direction and the negative direction are respectively on one side and another side on the Z axis with respect to the XY plane.

2. The irradiation device according to claim 1, wherein a distance to the first intersection from the XY plane is equal to a distance to the second intersection from the XY plane.

3. The irradiation device according to claim 1, wherein the central angle is 180°.

4. The irradiation device according to claim 1, wherein an angle formed by the light-emitting surface of the first light-emitting element and the XY plane is equal to an angle formed by the light-emitting surface of the second light-emitting element and the XY plane, and
the first light-emitting element and the second light-emitting element have different Z coordinates.

5. The irradiation device according to claim 4, wherein
$$\sqrt{X {1}^{2} + Y {1}^{2} + Z {1}^{2}} = \sqrt{X {2}^{2} + Y {2}^{2} + Z {2}^{2}}$$
is satisfied, where an origin is a center of the reactive region of the analytical chip in a state of being properly loaded at the load position, X1, Y1, and Z1 denote a position of the first light-emitting element, and X2, Y2, and Z2 denote a position of the second light-emitting element.

6. The irradiation device according to claim 1, comprising a plurality of light-emitting element pairs each including a set of the first light-emitting element and the second light-emitting element, the light-emitting element pairs being different from each other in wavelength range.

7. The irradiation device according to claim 5, comprising a plurality of light-emitting element pairs each including a set of the first light-emitting element and the second light-emitting element, the light-emitting element pairs being different from each other in wavelength range, wherein
a sum of a first inclination angle between a straight line connecting a center of the first light-emitting element to the origin and the Z axis and a second inclination angle between a straight line connecting a center of the second light-emitting element to the origin and the Z axis is same between at least two light-emitting element pairs among the plurality of light-emitting element pairs.

8. The irradiation device according to claim 7, wherein the first inclination angle and the second inclination angle of one of the two light-emitting element pairs are same as one of the first inclination angle and the second inclination angle of another one of the two light-emitting element pairs.

9. The irradiation device according to claim 1, wherein the light-emitting elements are light-emitting diodes.

10. A photometric device configured to optically analyze a test substance sample by using an analytical chip having a reactive region where a reagent reacting with a test target substance is immobilized, the photometric device comprising:
the irradiation device according to claim 1; and
a photodetector configured to detect output light output from the analytical chip when the analytical chip is irradiated with the light and output a detection signal corresponding to the output light.
